(19) United States
(12) Patent Application Publication
(10) Pub. No.: US 2025/0240760 A1
(43) Pub. Date: Jul. 24, 2025

(54) MEASUREMENT METHOD AND TERMINAL DEVICE

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN)

(73) Assignee: GUANGDONG OPPO MOBILE TELECOMMUNICATIONS CORP., LTD., Dongguan (CN)

(21) Appl. No.: 19/173,014

(22) Filed: Apr. 8, 2025

Related U.S. Application Data
(63) Continuation of application No. PCT/CN2023/071341, filed on Jan. 9, 2023.

(51) Int. Cl. H04W 64/00; H04W 24/10; H04W 76/19; H04W 76/20

(52) U.S. Cl. CPC H04W 64/00; H04W 24/10; H04W 76/19; H04W 76/20

(57) ABSTRACT

Provided are a measurement method and a terminal device. The measurement method comprises: a terminal device determines to execute a first GNSS operation according to a first condition, wherein the first condition is related to GNSS measurement. In embodiments of the present application, the terminal device can determine subsequent GNSS operations according to a condition (the first condition) related to the GNSS measurement.

### CROSS-REFERENCE TO RELATED APPLICATIONS

This application is a continuation of International Application No. PCT/CN2023/071341, filed on Jan. 9, 2023, the disclosure of which is hereby incorporated by reference in its entirety.

### TECHNICAL FIELD

This application relates to the field of communications technologies, and more specifically, to a measurement method and a terminal device.

### BACKGROUND

In some communications systems (for example, a new radio (NR) system), a terminal device that accesses a non-terrestrial network (NTN) may perform global navigation satellite system (GNSS) measurement in a radio resource control (RRC) connected state. However, it is currently unclear how a terminal device should perform GNSS measurement when GNSS location information of the terminal device is invalid or unavailable, after introducing the scheme of performing GNSS measurement by the terminal device in the RRC connected state.

### SUMMARY

This application provides a measurement method and a terminal device. The following describes the aspects related to this application.

According to a first aspect, there is provided a measurement method. The measurement method includes: determining, by a terminal device based on a first condition, to perform a first GNSS operation, where the first condition is related to GNSS measurement.

According to a second aspect, there is provided a terminal device. The terminal device includes: a determining module, configured to determine, based on a first condition, to perform a first GNSS operation, where the first condition is related to GNSS measurement.

According to a third aspect, there is provided a terminal device. The terminal device includes a processor and a memory. The memory is configured to store one or more computer programs, and the processor is configured to invoke the computer program in the memory to cause the terminal device to perform some or all of the steps of the method according to the first aspect.

According to a fourth aspect, an embodiment of this application provides a communications system, where the system includes the foregoing terminal device. In another possible design, the system may further include another device that interacts with the terminal device in the solution provided in embodiments of this application.

According to a fifth aspect, an embodiment of this application provides a computer-readable storage medium. The computer-readable storage medium stores a computer program, and the computer program causes a terminal device to perform some or all of the steps of the methods according to the foregoing aspects.

According to a sixth aspect, an embodiment of this application provides a computer program product. The computer program product includes a non-transitory computer-readable storage medium that stores a computer program, and the computer program is operable to cause a terminal device to perform some or all of the steps of the methods according to the foregoing aspects. In some implementations, the computer program product may be a software installation package.

According to a seventh aspect, an embodiment of this application provides a chip. The chip includes a memory and a processor, and the processor may invoke and run a computer program in the memory, to implement some or all of the steps of the methods according to the foregoing aspects.

### BRIEF DESCRIPTION OF DRAWINGS

FIG. 1 is an example diagram of a system architecture of a wireless communications system to which embodiments of this application are applicable.

FIG. 2 is an example diagram of a transparent payload NTN network architecture.

FIG. 3 is an example diagram of a regenerative payload NTN network architecture.

FIG. 4 is a schematic flowchart of a measurement method according to an embodiment of this application.

FIG. 5 is a schematic flowchart of a measurement method according to another embodiment of this application.

FIG. 6 is a schematic structural diagram of a terminal device according to an embodiment of this application.

FIG. 7 is a schematic structural diagram of a communications apparatus according to an embodiment of this application.

### DESCRIPTION OF EMBODIMENTS

### Communications System Architecture

The technical solutions in embodiments of this application may be applied to various communications systems, for example, a global system for mobile communications (GSM), a code-division multiple access (CDMA) system, a wideband code-division multiple access (WCDMA) system, general packet radio service (GPRS), a long-term evolution (LTE) system, an advanced long-term evolution (LTE-A) system, a new radio (NR) system, an evolved system of an NR system, an LTE-based access to unlicensed spectrum (LTE-U) system, an NR-based access to unlicensed spectrum (NR-U) system, an NTN system, a universal mobile telecommunications system (UMTS), a wireless local area network (WLAN), wireless fidelity (WiFi), a fifth-generation (5th-generation, 5G) system, or another communications system, for example, a future communications system such as a sixth-generation mobile communications system or a satellite communications system.

Generally, a quantity of connections supported by a conventional communications system is limited, and is also easy to implement. However, with development of communication technologies, a mobile communications system not only supports conventional communication, but also supports, for example, device-to-device (D2D) communication, machine-to-machine (M2M) communication, machine type communication (MTC), vehicle-to-vehicle (V2V) communication, or vehicle to everything (V2X) communication. Embodiments of this application may also be applied to these communications systems.

The communications system in embodiments of this application may be applied to a carrier aggregation (CA) scenario, a dual connectivity (DC) scenario, or a standalone (SA) networking scenario.

The communications system in embodiments of this application may be applied to an unlicensed spectrum, and the unlicensed spectrum may also be considered as a shared spectrum. Alternatively, the communications system in embodiments of this application may be applied to a licensed spectrum, and the licensed spectrum may also be considered as a dedicated spectrum.

Embodiments of this application may be applied to an NTN system, or may be applied to a terrestrial communication network (TN) system. By way of example rather than limitation, the NTN system includes an NR-based NTN system and an internet of things (IoT)-based NTN system. For example, in a scenario in which an NTN is accessed using narrow band internet of things (NB-IoT) and enhanced machine type communication (MTC), a system formed by an IoT terminal device and an NTN network may be understood as an NTN system based on IoT.

Embodiments of this application are described with reference to a network device and a terminal device. The terminal device may also be referred to as a user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, a user apparatus or the like.

In embodiments of this application, the terminal device may be a STATION (ST) in a WLAN, or may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, an in-vehicle device, a wearable device, a next-generation communications system such as a terminal device in an NR network, or a terminal device in a future evolved public land mobile network (PLMN) network.

In embodiments of this application, the terminal device may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, the terminal device may be configured to serve as a base station. For example, the terminal device may function as a scheduling entity, which provides a sidelink signal between terminal devices in V2X, D2D, or the like. For example, a cellular phone and a vehicle communicate with each other by using a sidelink signal. A cellular phone and a smart home device communicate with each other, without the relay of a communication signal through a base station.

The network device in embodiments of this application may be a device configured to communicate with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover devices having the following various names, or may be interchanged with the devices having following names, such as a NodeB, an evolved NodeB (eNB), a next generation NodeB (gNB), a relay station, an access point, a transmitting and receiving point (TRP), a transmitting point (TP), a master eNode MeNB, a secondary cNode SeNB, a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device-to-device D2D, vehicle-to-everything (V2X), and machine-to-machine (M2M) communications, a network-side device in a 6G network, a device that functions as a base station in a future communications system, or the like. The base station may support networks of a same access technology or different access technologies. A specific technology and a specific device form used by the network device are not limited in embodiments of this application.

The base station may be stationary or mobile. For example, a helicopter or an unmanned aerial vehicle may be configured to function as a mobile base station, and one or more cells may move depending on a location of the mobile base station. In other examples, a helicopter or an unmanned aerial vehicle may be configured to function as a device that communicates with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

By way of example rather than limitation, in embodiments of this application, the network device may have a mobility characteristic. For example, the network device may be a mobile device. In some embodiments of this application, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments of this application, the network device may alternatively be a base station located on land, water, or the like.

In embodiments of this application, the network device may provide a service for a cell, and the terminal device communicates with the network device by using a transmission resource (for example, a frequency domain resource or a spectrum resource) used by the cell. The cell may be a cell corresponding to the network device (for example, a base station). The cell may belong to a macro base station or belong to a base station corresponding to a small cell. The small cell herein may include a metro cell, a micro cell, a pico cell, a femto cell, or the like. These small cells feature small coverage and low transmit power, and are suitable for providing a high-speed data transmission service.

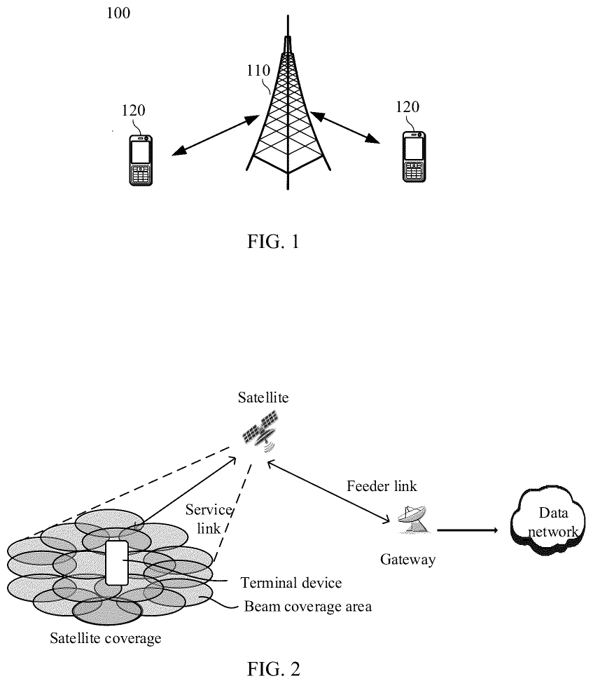

For example, FIG. 1 is a schematic diagram of an architecture of a communications system according to an embodiment of this application. As shown in FIG. 1, a communications system 100 may include a network device 110 and a terminal device 120, and the network device 110 may be a device that communicates with the terminal device 120 (or referred to as a communications terminal or a terminal). The network device 110 may provide communication coverage for a specific geographical region, and may communicate with a terminal device within the coverage region. For example, the network device may be a satellite.

FIG. 1 exemplarily shows one network device and two terminal devices. In some embodiments of this application, the communications system 100 may include a plurality of network devices and another quantity of terminal devices may be included within a coverage area of each network device, which is not limited in embodiments of this application.

It should be noted that FIG. 1 is merely an example of a system to which this application is applicable. Certainly, the methods shown in embodiments of this application may also be applied to another system, such as a 5G communications system or an LTE communications system. This is not specifically limited in embodiments of this application.

In some embodiments of this application, the wireless communications system shown in FIG. 1 may further include another network entity such as a mobility management entity (MME) or an access and mobility management function (AMF), which is not limited in the embodiment of this application.

As described above, the technical solutions provided in embodiments of this application may be applied to an NTN system. For ease of understanding, some related technical knowledge (for example, an NTN network architecture) related to embodiments of this application is first introduced. The following related technologies, as optional solutions, may be randomly combined with the technical solutions of embodiments of this application, all of which fall within the protection scope of embodiments of this application. Embodiments of this application include at least part of the following content.

### NTN

Currently, the 3rd generation partnership project (3GPP) is currently researching NTN technologies. An NTN generally provides a terrestrial user with a communication service through satellite communication. The satellite communication has many unique advantages over terrestrial communication networks (such as a terrestrial cellular communication).

First, the satellite communication is not limited by a geographic location of a user. For example, a general terrestrial communication network cannot cover an area such as an ocean, a mountain, or a desert in which a network device cannot be set up. For another example, the terrestrial communication network cannot cover some areas that is not provided with communication coverage due to sparse population. However, for the satellite communication, since one satellite can cover a relatively large terrestrial area, and the satellite can orbit the earth, theoretically, every corner of the earth can be covered by a satellite communication network.

Second, satellite communication has great social value. Satellite communication may cover remote mountainous areas, impoverished countries or regions at relatively low costs, thereby enabling people in these regions to enjoy advanced voice communication and mobile internet technologies. From this point of view, satellite communication is conducive to narrowing a digital divide between these regions and developed regions and promoting development of these regions.

Third, the satellite communication has a long distance, and communication cost does not significantly increase with an increase in the communication distance.

Finally, the satellite communication has high stability, and is not affected by natural disasters.

Communication satellites may be classified into LEO satellites, MEO satellites, GEO satellites, HEO satellites, and the like according to different orbital altitudes. At this stage, the main study is on the LEO satellite and the GEO satellite.

An altitude of the LEO satellite generally ranges from 500 km to 1500 km. Correspondingly, an orbital period of the LEO satellite is about 1.5 hours to 2 hours. For the LEO satellite, a signal propagation delay of single-hop communication between users is generally less than 20 ms. A maximum satellite visible time corresponding to the LEO satellite is about 20 minutes. The LEO satellite has advantages of a short signal propagation distance, a small link loss, and a low transmit power requirement for a terminal device.

An orbital altitude of the GEO satellite is about 35786 km. A period for the GEO satellite to rotate around the earth is 24 hours. For the GEO satellite, a signal propagation delay of single-hop communication between users is generally about 250 ms.

To ensure satellite coverage and improve system capacity of the entire satellite communication system, a satellite generally uses a plurality of beams to cover ground areas, and therefore one satellite may generate dozens or even hundreds of beams to cover the ground areas. One beam of a satellite may cover a terrestrial area with a diameter of approximately tens to hundreds of kilometers.

Currently, an NTN system may include an NR NTN system and an IoT NTN system.

### NTN Network Architecture

The NTN network architecture may include the following network elements: a gateway, a feeder link, a service link, and a satellite.

The NTN network architecture may include one or more gateways, and the one or more gateways may be configured to connect a satellite to a terrestrial public network.

The feeder link may refer to a link for communication between the gateway and the satellite.

The service link may refer to a link for communication between a terminal device and the satellite.

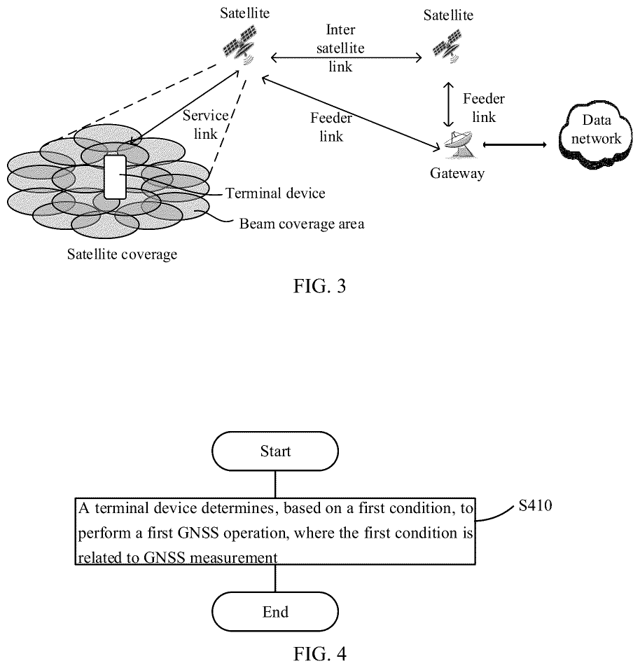

Satellites may be classified into a transparent payload satellite and a regenerative payload satellite in terms of functions provided by the satellites. The transparent payload satellite refers to a satellite that provides only radio frequency filtering, frequency conversion, and amplification. In other words, the transparent payload satellite provides only transparent forwarding of signals, and does not change waveform signals forwarded by the satellite. The regenerative payload satellite refers to a satellite that may provide one or more of the following functions: demodulation, decoding, routing, conversion, encoding, or modulation, in addition to providing functions of radio frequency filtering, frequency conversion, and amplification. The regenerative payload satellite may have some or all of functions of a base station. Depending on different functions provided by satellites in an NTN network, NTN network architectures may be classified into a transparent payload NTN network architecture and a regenerative payload NTN network architecture. FIG. 2 and FIG. 3 are example diagrams of a transparent payload NTN network architecture and a regenerative payload NTN network architecture, respectively.

In some embodiments, the NTN network architecture may further include an inter satellite link (ISL). For example, the inter satellite link may exist in the regenerative payload NTN network architecture.

### Timing Advance (TA) in a TN

An important feature of uplink transmission is orthogonal multiple access of different terminal devices in time and frequency domain, that is, uplink transmissions of different terminal devices in a same cell do not interfere with each other. In order to ensure orthogonality of uplink transmissions and avoid intra-cell interference, the network device requires that signals, at a same instant but on different frequency domain resources, from different terminal devices arrive at the network device with time-aligned. To ensure time synchronization on the network device side, a communications system (for example, an LTE/NR system) may support a mechanism of uplink TA.

In the communications system that supports uplink TA, an uplink clock and a downlink clock on a network device side are the same, there is an offset between an uplink clock and a downlink clock on a terminal device side, and different terminal devices have respective different uplink TA values. By appropriately controlling an offset of each terminal device, the network device may control time at which uplink signals from different terminal devices arrive at the network device. Due to a relatively large transmission delay, a terminal device that is relatively far away from the network device transmits uplink data earlier than a terminal device that is relatively close to the network device.

The network device may determine a TA value of each terminal device by measuring uplink transmission of the terminal device. The network device may transmit a TA command to the terminal device to notify the terminal device of a TA value corresponding to the terminal device. For example, the network device may transmit the TA command to the terminal device in two manners, which are specifically as follows.

Manner 1: Acquisition of an initial TA. In a random access procedure, the network device may determine a TA value by measuring a received preamble, and transmit the TA value to the terminal device by using a timing advance command ( ) field in a random access response (RAR) message.

Manner 2: Adjustment of TA in an RRC connected state. Although in a random access procedure, the terminal device achieves uplink synchronization with the network device, timing when an uplink signal arrives at the network device may change with time. Therefore, the terminal device is required to continuously update an uplink TA value of the terminal device to maintain uplink synchronization. If TA of a terminal device is required to be corrected, the network device may transmit a TA command (Timing Advance Command) to the terminal device to request the terminal device to adjust uplink timing. In some implementations, the TA command is transmitted by the network device to the terminal device by using a medium access control control element (MAC CE). This MAC CE may also be referred to as a TA command MAC CE (namely, a MAC CE that carries a TA command).

### TA in an NTN

It may be learned from the foregoing description that, in a conventional TN network, a terminal device may maintain its TA based on a TA command issued by a network device. As in the TN system, in the NTN system (for example, release 17 (R17)), an impact of TA is also required to be considered when the terminal device performs uplink transmission. In the NTN system, the terminal device generally has a GNSS positioning capability and a TA pre-compensation capability. The terminal device may autonomously estimate, based on a location of the terminal device and a location of a serving satellite, TA corresponding to a service link. In an implementation, a TA determination method combining open loop and closed loop is introduced in the NTN. Based on conclusions from current standardization meetings, for a terminal device in an RRC idle state (RRC_IDLE)/RRC inactive state (RRC_INACTIVE) and an RRC connected state (RRC_CONNECTED), TA of the terminal device that accesses an NTN may be calculated according to the following formula:

$${T}_{TA} = ( {N}_{TA} + {N}_{TA , UE - specific} + {N}_{TA , common} + {N}_{TA , offset} ) \times {T}_{c}$$

where T_{TA} represents TA of the terminal device that accesses the NTN. N_{TA} represents a TA adjustment amount controlled by the network device, is defined as 0 for a scenario where a physical random access channel (PRACH) is transmitted, and may be subsequently updated by using a TA command in a message 2 (Msg2) or a message B (MsgB) and a TA command MAC CE. N_{TA,UE-specific} represents TA corresponding to a service link (or referred to as service link TA) that is estimated by the terminal device, and is used for TA pre-compensation. In an implementation, a terminal device may learn a location of a satellite based on GNSS location information acquired by the terminal device and satellite ephemeris information broadcast by a serving cell, so as to calculate a propagation delay of the service link from the terminal device to the satellite. N_{TA,common} represents common TA controlled by the network device, and includes any timing offset considered necessary by a network, for example, may be TA corresponding to a feeder link, or may be another value. N_{TA,offset} represents a preset offset value, for example, may be a fixed offset value for calculating TA.

It may be seen from the foregoing formula that, to acquire the TA corresponding to the service link (namely, N_{TA,UE-specific}), a terminal device that accesses an NTN (for example, an NTN terminal device in an RRC connected state) is required to learn its own GNSS location information and is also required to learn a location of a serving satellite based on satellite ephemeris information of the serving cell. In addition, to calculate TA of the terminal device, the UE is also required to acquire the common TA (namely, N_{TA,common}).

### GNSS Operation for an IoT NTN

In an IoT NTN (for example, a scenario where an NB-IoT or eMTC terminal device accesses an NTN), a GNSS measurement module and a communications module of an IoT terminal device cannot be simultaneously operated (Simultaneous GNSS and NTN NB-IoT/eMTC operation is not assumed). In R17 IoT NTN, the IoT terminal device can perform GNSS measurement to acquire GNSS location information only in an RRC idle state or an RRC inactive state, and a GNSS module cannot be started in an RRC connected state. Thus, before entering the RRC connected state, the terminal device is required to first acquire a GNSS location of the terminal device by performing measurement using the GNSS module, and the terminal device may then determine, based on a status of the terminal device (for example, a moving state of the terminal device), validity duration of the GNSS location, and report, to a network during RRC connection establishment or RRC re-establishment or RRC connection restoration, remaining validity duration corresponding to the GNSS location. For a terminal device in an RRC connected state, when the GNSS location of the terminal device expires, since the terminal device cannot perform a GNSS operation in the RRC connected state, the terminal device cannot perform some subsequent operations based on GNSS location information, for example, cannot calculate TA. In this case, the terminal device is required to return to the RRC idle state and perform a GNSS operation.

In release 18 (R18), enhancement to IoT NTN performance is proposed, to resolve the problem left unresolved in R17. The enhancement to IoT NTN performance in R18 is based on R17 IoT-NTN as a reference, and is performed based on results from R17 NR-NTN. Further objectives for the enhancement to IoT-NTN performance are as follows: (1) disabling of hybrid automatic repeat request (HARQ) feedback to mitigate an impact of HARQ stalling on data rates of a terminal device (disabling of HARQ feedback to mitigate impact of HARQ stalling on UE data rates); and (2) studying and specifying, if needed, of improved GNSS operations for new location information for UE pre-compensation during long connection times and for reduced power consumption (Study and specify, if needed, improved GNSS operations for a new position fix for UE pre-compensation during long connection times and for reduced power consumption).

In view of the above study objectives, how an IoT terminal device accessing an NTN can perform GNSS measurement (or understood as acquiring GNSS location information (GNSS position fix) and the like) in the RRC connected state is discussed in R18. Specifically, conclusions drawn from the discussions on GNSS enhancement for an IoT terminal device accessing an NTN in R18 may include the following aspects.

First aspect: An IoT NTN terminal device may need to re-acquire valid GNSS location information during an RRC connection with a relatively long duration. Furthermore, in this case, it is also necessary to consider how the terminal device updates GNSS location information or reduces needs for updating GNSS location information during the RRC connected state.

Second aspect: how the terminal device performs GNSS measurement in the RRC connected state. For example, the following candidate solutions may be considered: Solution 1: The terminal device re-acquires GNSS location information under control of a timer. Solution 2: A new measurement gap is introduced, and the terminal device re-acquires GNSS location information during the measurement gap.

Third aspect: how GNSS measurement is triggered when the terminal device is in the RRC connected state. In a possible implementation, GNSS measurement may be triggered by a network. In another possible implementation, GNSS measurement may be triggered by the terminal device.

It may be seen that, at present, the terminal device may perform GNSS measurement in the RRC connected state. However, it is currently unclear how a terminal device should perform GNSS measurement when GNSS location information of the terminal device is invalid or unavailable, after introducing the scheme of performing GNSS measurement by the terminal device in the RRC connected state. For example, if current GNSS location information of the terminal device is invalid or unavailable, and the terminal device receives no command for triggering GNSS measurement from the network device, it is unclear how the terminal device performs GNSS measurement. For another example, assuming that the terminal device receives no command for triggering GNSS measurement from the network device, the terminal device may autonomously perform GNSS measurement. However, whether the terminal device is allowed to autonomously perform GNSS measurement may depend on configuration by the network device. In this case, if the network device has not configured, for the terminal device, that the terminal device is allowed to autonomously start GNSS measurement, then when current GNSS location information of the terminal device is invalid or unavailable, there is currently no clear solution for how the terminal device should perform GNSS measurement.

Therefore, when the current GNSS location information of the terminal device is invalid or unavailable, how the UE should perform GNSS measurement is a problem to be resolved.

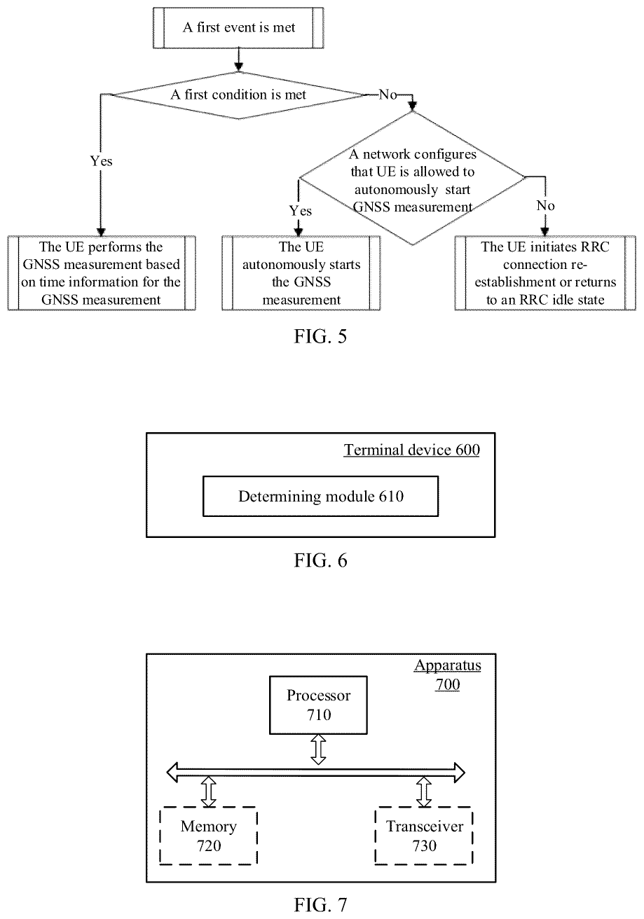

To resolve the foregoing problem, embodiments of this application provide a measurement method and a terminal device, such that the terminal device can determine a subsequent GNSS operation based on a condition (that is, the first condition hereinafter) related to GNSS measurement. In this way, the terminal device may perform different GNSS operations based on the first condition, to complete GNSS measurement, facilitating formulating an appropriate GNSS measurement scheme, and further facilitating reducing signalling overheads or reducing a service transmission delay. The method embodiments of this application are described below with reference to FIG. 4 and FIG. 5.

FIG. 4 is a schematic flowchart of a measurement method according to an embodiment of this application. The method shown in FIG. 4 may be executed by a terminal device. The terminal device may be, for example, any one of terminal devices shown in FIG. 1 to FIG. 3. In some embodiments, the terminal device may refer to a terminal device that accesses an NTN. In some embodiments, the terminal device may refer to a terminal device that is in an RRC connected state.

The method shown in FIG. 4 may include step S410. The following describes the step.

In step S410, a terminal device determines, based on a first condition, to perform a first GNSS operation. The first condition is related to GNSS measurement.

In embodiments of this application, the first condition is a condition related to GNSS measurement. In other words, the first condition is determined based on information associated with GNSS measurement.

In some embodiments, the condition related to GNSS measurement or the information associated with GNSS measurement may include information related to a manner of triggering GNSS measurement when the terminal device is in an RRC connected state, for example, information related to a network triggering GNSS measurement or the terminal device triggering GNSS measurement.

In some embodiments, the condition related to GNSS measurement or the information associated with GNSS measurement may include information related to how to perform GNSS measurement when the terminal device is in the RRC connected state. For example, the terminal device may perform GNSS measurement based on a timer or the terminal device may perform GNSS measurement based on a measurement gap.

In some embodiments, the condition related to GNSS measurement or the information associated with GNSS measurement may include indication information used for indicating whether the terminal device is allowed to perform GNSS measurement in the RRC connected state.

In embodiments of this application, in addition to the information listed above, the condition related to GNSS measurement or the information associated with GNSS measurement may include other information associated with GNSS, for example, information about a resource for the terminal device to perform GNSS measurement, which is not limited in embodiments of this application. The following exemplarily describes a preferred solution for the first condition mentioned in this embodiment of this application.

In some embodiments, the first condition may be associated with one or more of the following information: information for triggering the GNSS measurement; or time information for performing the GNSS measurement.

In some embodiments, the information for triggering the GNSS measurement may include a command for triggering GNSS measurement from a network. The terminal device may determine, based on the information for triggering the GNSS measurement, whether the network requires the terminal device to perform the GNSS measurement.

In some embodiments, the information for triggering the GNSS measurement may be transmitted to the terminal device by the network device.

In some embodiments, the terminal device may determine, based on the time information for performing the GNSS measurement, a time domain location for performing the GNSS measurement, so as to perform the GNSS measurement at the time domain location. In some embodiments, the time information for performing the GNSS measurement may include information about a GNSS measurement gap. In this way, the terminal device may perform the GNSS measurement in the measurement gap. However, embodiments of this application are not limited to this. For example, the time information for performing the GNSS measurement may include, for example, indication information. The indication information is used for indicating a time domain location (for example, one or some slots, or one or some symbols), so that the terminal device performs the GNSS measurement at the corresponding time domain location.

In some embodiments, the time information for performing the GNSS measurement may be transmitted to the terminal device by the network device.

In some embodiments, the first condition may include one or more of the following: information for triggering the GNSS measurement is received by the terminal device; or the information about a GNSS measurement gap is received by the terminal device.

In embodiments of this application, the terminal device may determine, based on the first condition, to perform the first GNSS operation. In other words, the terminal device may perform different GNSS operations based on whether the first condition is met and/or whether different first conditions are met, to determine a preferred GNSS measurement scheme corresponding to the terminal device in a current situation.

In some embodiments, the first GNSS operation may be used to indicate a manner in which the terminal device performs the GNSS measurement, that is, the terminal device may determine, based on the first condition, a manner in which the GNSS measurement is to be performed, and perform the GNSS measurement in this manner.

In some embodiments, the first GNSS operation may be used to instruct the terminal device to remain in the RRC connected state to perform the GNSS measurement. In some embodiments, the first GNSS operation may be used to instruct the terminal device to exit the RRC connected state (for example, enter the RRC idle state or the RRC inactive state) and perform the GNSS measurement.

For example, the first GNSS operation may include one or more of the following: performing the GNSS measurement based on time information for the GNSS measurement; triggering RRC connection re-establishment, and performing the GNSS measurement before initiating an RRC connection re-establishment request; or entering an RRC idle state, and performing the GNSS measurement before next RRC connection establishment.

Depending on different first conditions and different first GNSS operations, the determining, by the terminal device based on the first condition, to perform the first GNSS operation may include a plurality of different possibilities, which are exemplarily described below with referent to FIG. 5.

In some embodiments, the determining, by the terminal device based on the first condition, to perform the first operation may include: determining, by the terminal device in a case that the terminal device meets the first condition, to perform the GNSS measurement based on time information for the GNSS measurement.

For example, if the terminal device receives the information about the GNSS measurement gap, the terminal device may determine, based on the received GNSS measurement gap, to perform the GNSS measurement. Alternatively, if the terminal device receives the information for triggering the GNSS measurement, the terminal device may perform the GNSS measurement based on the information for triggering the GNSS measurement. Alternatively, if the terminal device receives the information for triggering the GNSS measurement and the information about the GNSS measurement gap, the terminal device may perform the GNSS measurement in the corresponding GNSS measurement gap based on the information for triggering the GNSS measurement.

In some embodiments, after the terminal device performs the GNSS measurement based on the time information for the GNSS measurement, the terminal device may start or re-start a first timer. During running of the first timer, the terminal device may consider that current GNSS location information is valid or available. For information related to the first timer, reference may be made to later description, and details are not described herein again.

In embodiments of this application, in a case in which the terminal device meets the first condition (for example, there is a GNSS measurement gap), the terminal device may remain in the RRC connected state as much as possible, and perform the GNSS measurement based on the information for triggering the GNSS measurement and/or using the GNSS measurement gap, thereby reducing signalling overheads and reducing service interruptions.

In some embodiments, the determining, by the terminal device based on the first condition, to perform the first operation may include: determining, by the terminal device in a case that the terminal device does not meet the first condition, to trigger RRC connection re-establishment and perform the GNSS measurement before initiating an RRC connection re-establishment request.

For example, if the terminal device neither receives the information for triggering the GNSS measurement, nor receives the information about a GNSS measurement gap, the terminal device may trigger RRC connection re-establishment, and perform GNSS measurement before initiating an RRC connection re-establishment request.

In some embodiments, if the terminal device does not meet the first condition and the terminal device is not allowed to autonomously start GNSS measurement, the terminal device determines to trigger RRC connection re-establishment, and perform GNSS measurement before initiating an RRC connection re-establishment request. It should be understood that, in this case, it may be considered that the first condition and the condition of whether the terminal device is allowed to autonomously start GNSS measurement are parallel conditions. In a case in which neither of the conditions is met, RRC connection re-establishment may be triggered, and the GNSS measurement may be performed before initiating an RRC connection re-establishment request. However, in a case in which one or more of the two conditions are met, the GNSS measurement may be performed based on the information for triggering the GNSS measurement or the GNSS measurement gap, or the GNSS measurement may be autonomously performed.

In some embodiments, that the terminal device is not allowed to autonomously start the GNSS measurement may include: the network device having not configured, for the terminal device, that the terminal device autonomously starts GNSS measurement in the RRC connected state.

In some embodiments, the terminal device triggering RRC connection re-establishment is dependent on configuration by the network device. In other words, in a case in which the network device configures, for the terminal device, that the terminal device is allowed to trigger RRC connection re-establishment in the RRC connected state, the terminal device can trigger RRC connection re-establishment in a case in which the first condition is not met, and perform GNSS measurement before initiating an RRC connection re-establishment request.

In some embodiments, the network device configuring, for the terminal device, whether the terminal device is allowed to trigger RRC connection re-establishment in the RRC connected state may refer to the network device configuring, for the terminal device, whether the terminal device is allowed to trigger RRC connection re-establishment in the RRC connected state in a case in which a condition related to the GNSS measurement is not met.

In the embodiments of this application, compared with performing the GNSS measurement in the RRC idle state, performing the GNSS measurement by the terminal device by triggering the RRC connection re-establishment procedure saves more higher-layer signalling and reduces a service transmission delay.

In some embodiments, the determining, by the terminal device based on the first condition, to perform the first operation may include: determining, by the terminal device in a case that the terminal device does not meet the first condition, to enter an RRC idle state, and performing GNSS measurement before next RRC connection establishment.

For example, if the terminal device neither receives the information for triggering the GNSS measurement, nor receives the information about a GNSS measurement gap, the terminal device may enter the RRC idle state, and perform the GNSS measurement before next RRC connection establishment.

In some embodiments, if the terminal device does not meet the first condition and the terminal device is not allowed to autonomously start the GNSS measurement, the terminal device determines to enter the RRC idle state, and performs the GNSS measurement before next RRC connection establishment. It should be understood that, in this case, it may be considered that the first condition and the condition of whether the terminal device is allowed to autonomously start the GNSS measurement are parallel conditions. In a case in which neither of the conditions is met, the terminal device may enter the RRC idle state, and perform the GNSS measurement before next RRC connection establishment. However, when one or more of the two conditions are met, the GNSS measurement may be performed based on the information for triggering the GNSS measurement or the GNSS measurement gap, or the GNSS measurement may be autonomously performed.

In embodiments of this application, the terminal device can enter the RRC idle state to perform the GNSS measurement, so that the implementation is simpler.

In some embodiments, if the terminal device does not meet the first condition, but the terminal device is allowed to autonomously start GNSS measurement, the terminal device may choose to autonomously start the GNSS measurement. For example, if the network device configures the terminal device to autonomously trigger GNSS measurement, the terminal device may autonomously start the GNSS measurement based on the configuration.

In conclusion, in embodiments of this application, depending on different first conditions and different first GNSS operations, the terminal device may determine, based on the first condition, to perform different GNSS operations, for example, determining whether to remain in the RRC connected state and perform GNSS measurement by using the GNSS measurement gap, or whether to trigger RRC connection re-establishment and complete the GNSS measurement before initiating a re-establishment procedure, or whether to return to the RRC idle state and complete the GNSS measurement before subsequent RRC connection establishment.

Continuing to refer to FIG. 5, in some embodiments, in a case in which a first event is triggered (occurs), the terminal device may determine, based on the first condition, to perform the first GNSS operation. In other words, the behavior that the terminal device determines, based on the first condition, to perform the first GNSS operation may be triggered by the first event, where the first event may be used to indicate that the current GNSS location information of the terminal device is invalid or unavailable.

In some embodiments, the first event may include one or more of the following: the terminal device determines (or judges) that the current GNSS location information of the terminal device is invalid or unavailable; or a timer expires.

In embodiments of this application, implementation of the terminal device determining whether the current GNSS location information of the terminal device is valid/available is not specifically limited. For example, the terminal device may determine, based on whether the timer expires, whether the current GNSS location information is valid/available, or the terminal device may determine, based on a moving status of the terminal device in combination with historically acquired GNSS location information, whether the current GNSS location information is valid/available.

In some embodiments, the timer may include a first timer, for example, a GNSS validity timer.

In some embodiments, during running of the first timer, the terminal device may consider that the current GNSS location information is valid or available. In other words, when the first timer expires, the terminal device may consider that the current GNSS location information is invalid or unavailable.

In some embodiments, the first timer may be started or re-started each time when the terminal device performs GNSS measurement or acquires GNSS location information.

Timing duration of the first timer is not limited in embodiments of this application, and may be specifically set depending on actual situations.

In some embodiments, the timing duration of the first timer may be determined by the terminal device. In some embodiments, the timing duration of the first timer may be configured by the network device. In an implementation, the network device may configure the timing duration of the first timer by using system information (for example, a system information block (SIB)) or RRC dedicated signalling.

In some embodiments, the timer expiring may include the first timer expiring.

In some embodiments, the timer may include a second timer. In some embodiments, the second timer may be used to control a period of time during which the terminal device considers that the current GNSS location information is valid, or a period of time during which the terminal device considers that uplink synchronization is valid.

In some embodiments, the second timer may be started or re-started each time when the terminal device receives information about TA adjustment and/or information about frequency offset adjustment. In this case, it may be considered that uplink time adjustment and uplink frequency adjustment are simultaneously controlled by the network, for example, controlled by same signalling (for example, MAC CE signalling). In other words, in this case, it may be considered that the same timer (the second timer) may be maintained for both uplink time adjustment and uplink frequency adjustment.

In some embodiments, during running of the second timer, the terminal device may consider that the current GNSS location information is valid or available.

Timing duration of the second timer is not limited in embodiments of this application, and may be specifically set depending on actual situations.

In some embodiments, the timing duration of the second timer may be configured by the network device. In an implementation, the network device may configure the timing duration of the second timer by using system information (for example, an SIB) or RRC dedicated signalling.

In some embodiments, the timer expiring may include the second timer expiring.

In some embodiments, the timer may include the first timer and the second timer. In this case, the timer expiring may include both the first timer and the second timer expiring, or the timer expiring may include either of the first timer and the second timer expiring.

In some embodiments, the timer may include a third timer and a fourth timer. In some embodiments, the third timer and the fourth timer may be used to control a period of time during which the terminal device considers that the current GNSS location information is valid, or a period of time during which the terminal device considers that uplink synchronization is valid.

In some embodiments, the third timer may be started or re-started each time when the terminal device receives information about TA adjustment, and the fourth timer may be started or re-started each time when the terminal device receives information about uplink frequency adjustment. In this case, it may be considered that uplink time adjustment and uplink frequency adjustment are separately controlled by the network, for example, controlled by using different signalling (for example, different MAC CE signalling). In other words, in this case, it may be considered that two timers (the third timer and the fourth timer) may be respectively maintained for uplink time adjustment and uplink frequency adjustment.

In some embodiments, in a case in which the third timer and the fourth timer may be respectively maintained for uplink time adjustment and uplink frequency adjustment, the third timer and the fourth timer may correspond to same timing duration, or may correspond to different timing durations, which is not limited in embodiments of this application.

In some embodiments, in a case in which the third timer and the fourth timer are respectively maintained for uplink time adjustment and uplink frequency adjustment, the timer expiring may include both the third timer and the fourth timer expiring, or either of the third timer and the fourth timer expiring.

In some embodiments, during running of the third timer and/or the fourth timer, the terminal device may consider that the current GNSS location information is valid or available.

Timing duration of the third timer and the fourth timer is not limited in embodiments of this application, and may be specifically set depending on actual situations.

In some embodiments, the timing duration of the third timer and the fourth timer may be configured by the network device. In an implementation, the network device may configure the timing duration of the third timer or the fourth timer by using system information (for example, an SIB) or RRC dedicated signalling.

In some embodiments, the timer may include the first timer, the third timer, and the fourth timer. In this case, the timer expiring may include the first timer, the third timer, and the fourth timer all expiring, or the timer expiring may include any one or more of the first timer, the third timer, and the fourth timer expiring.

In embodiments of this application, when the first event occurs, the terminal device can determine subsequent behavior based on the first condition, for example, remain in the RRC connected state to perform GNSS measurement, or exit the RRC connected state to perform GNSS measurement, facilitating formulating, by the terminal device according to a current situation, an appropriate GNSS measurement scheme.

The methods embodiments of this application are described in detail above with reference to FIG. 1 to FIG. 5. The apparatus embodiments of this application are described in detail below with reference to FIG. 6 and FIG. 7. It should be understood that the description of the method embodiments corresponds to the description of the apparatus embodiments, and therefore, for parts that are not described in detail, reference may be made to the foregoing method embodiments.

FIG. 6 is a schematic structural diagram of a terminal device according to an embodiment of this application. A terminal device 600 shown in FIG. 6 may include a determining module 610.

The determining module 610 may be configured to determine, based on a first condition, to perform a first GNSS operation, where the first condition is related to GNSS measurement.

In some implementations, the first condition is associated with one or more of the following information: information for triggering the GNSS measurement; or time information for performing the GNSS measurement.

In some implementations, the first condition includes one or more of the following: information for triggering the GNSS measurement is received by the terminal device; or information about a GNSS measurement gap is received by the terminal device.

In some implementations, the first GNSS operation includes one or more of the following operations: performing the GNSS measurement based on time information for the GNSS measurement; triggering radio resource control RRC connection re-establishment, and performing the GNSS measurement before initiating an RRC connection re-establishment request; or entering an RRC idle state, and performing the GNSS measurement before next RRC connection establishment.

In some implementations, the determining module 610 is further configured to: determine, in a case that the terminal device meets the first condition, to perform the GNSS measurement based on time information for the GNSS measurement; determine, in a case that the terminal device does not meet the first condition, to trigger RRC connection re-establishment and perform the GNSS measurement before initiating an RRC connection re-establishment request; or determine, in a case that the terminal device does not meet the first condition, to enter an RRC idle state and perform the GNSS measurement before next RRC connection establishment.

In some implementations, the determining, in a case that the terminal device does not meet the first condition, to trigger RRC connection re-establishment and perform the GNSS measurement before initiating an RRC connection re-establishment request includes: in a case that the terminal device does not meet the first condition and the terminal device is not allowed to autonomously start the GNSS measurement, determining to trigger RRC connection re-establishment and perform the GNSS measurement before initiating an RRC connection re-establishment request; and the determining, in a case that the terminal device does not meet the first condition, to enter an RRC idle state and perform the GNSS measurement before next RRC connection establishment includes: in a case that the terminal device does not meet the first condition and the terminal device is not allowed to autonomously start the GNSS measurement, determining to enter the RRC idle state and perform the GNSS measurement before next RRC connection establishment.

In some implementations, the determining module 610 is further configured to: when a first event is triggered, determine, based on the first condition, to perform the first GNSS operation, where the first event is used to indicate that current GNSS location information of the terminal device is invalid or unavailable.

In some implementations, the first event includes one or more the following: the terminal device determines that the current GNSS location information of the terminal device is invalid or unavailable; or a timer expires.

In some implementations, the timer includes a first timer, where the first timer is started or re-started when the terminal device performs GNSS measurement or acquires GNSS location information.

In some implementations, the timer further includes a second timer, and the second timer is started or re-started when information about timing advance adjustment and/or information about frequency offset adjustment is received by the terminal device, where the timer expiring includes both the first timer and the second timer expiring, or either of the first timer and the second timer expiring; or the timer further includes a third timer and a fourth timer, the third timer is started or re-started when information about timing advance adjustment is received by the terminal device, and the fourth timer is started or re-started when information about frequency offset adjustment is received by the terminal device, where the timer expiring includes the first timer, the third timer, and the fourth timer all expiring, or any one or more of the first timer, the third timer, and the fourth timer expiring.

In some implementations, the terminal device is a terminal device that accesses a non-terrestrial network NTN, and the terminal device is in an RRC connected state.

In some implementations, the determining module 610 may be a processor 710. The terminal device 600 may further include a transceiver 730 and a memory 720. Details are shown in FIG. 7.

FIG. 7 is a schematic structural diagram of a communications apparatus according to an embodiment of this application. Dashed lines in FIG. 7 indicate that a unit or module is optional. The apparatus 700 may be configured to implement the methods described in the foregoing method embodiments. The apparatus 700 may be a chip, a terminal device, or a network device.

The apparatus 700 may include one or more processors 710. The processor 710 may support the apparatus 700 in implementing the methods described in the foregoing method embodiments. The processor 710 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 700 may further include one or more memories 720. The memory 720 stores a program that may be executed by the processor 710 to cause the processor 710 to perform the methods described in the foregoing method embodiments. The memory 720 may be separate from the processor 710 or may be integrated into the processor 710.

The apparatus 700 may further include a transceiver 730. The processor 710 may communicate with another device or chip through the transceiver 730. For example, the processor 710 may transmit data to and receive data from another device or chip through the transceiver 730.

An embodiment of this application further provides a computer-readable storage medium for storing a program. The computer-readable storage medium may be applied to the terminal or the network device provided in the embodiments of this application, and the program causes a computer to perform the methods performed by the terminal or the network device in various embodiments of this application.

An embodiment of this application further provides a computer program product. The computer program product includes a program. The computer program product may be applied to the terminal or the network device provided in the embodiments of this application, and the program causes a computer to perform the methods performed by the terminal or the network device in various embodiments of this application.

An embodiment of this application further provides a computer program. The computer program may be applied to the terminal or the network device provided in embodiments of this application, and the computer program causes a computer to execute the methods performed by the terminal or the network device in various embodiments of this application.

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indication” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “pre-configured” may be implemented by pre-storing corresponding code, tables, or other forms that may be used to indicate related information in devices (for example, including a terminal device and a network device), and a specific implementation thereof is not limited in this application. For example, predefined may indicate being defined in a protocol.

In embodiments of this application, the “protocol” may indicate a standard protocol in the communications field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in the specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A measurement method, comprising:
determining, by a terminal device based on a first condition, to perform a first global navigation satellite system (GNSS) operation, wherein the first condition is related to GNSS measurement.

2. The method according to claim 1, wherein the first condition comprises:
information for triggering the GNSS measurement is received by the terminal device.

3. The method according to claim 1, wherein the first condition comprises:
information about a GNSS measurement gap is received by the terminal device.

4. The method according to claim 1, wherein the first GNSS operation comprises:
performing the GNSS measurement based on time information for the GNSS measurement.

5. The method according to claim 1, wherein the first GNSS operation comprises:
triggering radio resource control (RRC) connection re-establishment, and performing the GNSS measurement before initiating an RRC connection re-establishment request.

6. The method according to claim 1, wherein the first GNSS operation comprises:
entering an RRC idle state, and performing the GNSS measurement before next RRC connection establishment.

7. The method according to claim 1, wherein the determining, by the terminal device based on the first condition, to perform the first GNSS operation comprises:
determining, by the terminal device in a case that the terminal device meets the first condition, to perform the GNSS measurement based on time information for the GNSS measurement.

8. The method according to claim 1, wherein the determining, by the terminal device based on the first condition, to perform the first GNSS operation comprises:
determining, by the terminal device in a case that the terminal device does not meet the first condition, to trigger RRC connection re-establishment and perform the GNSS measurement before initiating an RRC connection re-establishment request.

9. The method according to claim 1, wherein the determining, by the terminal device based on the first condition, to perform the first GNSS operation comprises:
determining, by the terminal device in a case that the terminal device does not meet the first condition, to enter an RRC idle state and perform the GNSS measurement before next RRC connection establishment.

10. The method according to claim 1, wherein the determining, by the terminal device based on the first condition, to perform the first GNSS operation comprises:
when a first event is triggered, determining, by the terminal device based on the first condition, to perform the first GNSS operation,
wherein the first event is used to indicate that current GNSS location information of the terminal device is invalid or unavailable.

11. A terminal device, comprising a processor configured to:
determine, based on a first condition, to perform a first global navigation satellite system (GNSS) operation, wherein the first condition is related to GNSS measurement.

12. The terminal device according to claim 11, wherein the first condition comprises one or more of following:
information for triggering the GNSS measurement is received by the terminal device; or
information about a GNSS measurement gap is received by the terminal device.

13. The terminal device according to claim 11, wherein the first GNSS operation comprises one or more of following operations:
performing the GNSS measurement based on time information for the GNSS measurement;
triggering radio resource control (RRC) connection re-establishment, and performing the GNSS measurement before initiating an RRC connection re-establishment request; or
entering an RRC idle state, and performing the GNSS measurement before next RRC connection establishment.

14. The terminal device according to claim 11, wherein the processor is further configured to:
determine, in a case that the terminal device meets the first condition, to perform the GNSS measurement based on time information for the GNSS measurement;
determine, in a case that the terminal device does not meet the first condition, to trigger RRC connection re-establishment and perform the GNSS measurement before initiating an RRC connection re-establishment request; or
determine, in a case that the terminal device does not meet the first condition, to enter an RRC idle state and perform the GNSS measurement before next RRC connection establishment.

15. The terminal device according to claim 11, wherein the processor is further configured to:
when a first event is triggered, determine, based on the first condition, to perform the first GNSS operation,
wherein the first event is used to indicate that current GNSS location information of the terminal device is invalid or unavailable.

16. A chip, comprising a processor, configured to invoke a program from a memory to cause a terminal device, on which the chip is installed, to determine, based on a first condition, to perform a first global navigation satellite system (GNSS) operation, wherein the first condition is related to GNSS measurement.

17. The chip according to claim 16, wherein the first condition comprises one or more of following:
information for triggering the GNSS measurement is received by the terminal device; or
information about a GNSS measurement gap is received by the terminal device.

18. The chip according to claim 16, wherein the first GNSS operation comprises one or more of following operations:
performing the GNSS measurement based on time information for the GNSS measurement;
triggering radio resource control (RRC) connection re-establishment, and performing the GNSS measurement before initiating an RRC connection re-establishment request; or
entering an RRC idle state, and performing the GNSS measurement before next RRC connection establishment.

19. The chip according to claim 16, wherein the processor is configured to invoke the program from the memory to cause the terminal device to:
determine, in a case that the terminal device meets the first condition, to perform the GNSS measurement based on time information for the GNSS measurement;
determine, in a case that the terminal device does not meet the first condition, to trigger RRC connection re-establishment and perform the GNSS measurement before initiating an RRC connection re-establishment request; or
determine, in a case that the terminal device does not meet the first condition, to enter an RRC idle state and perform the GNSS measurement before next RRC connection establishment.

20. The chip according to claim 16, wherein the processor is configured to invoke the program from the memory to cause the terminal device to:
when a first event is triggered, determine, based on the first condition, to perform the first GNSS operation,
wherein the first event is used to indicate that current GNSS location information of the terminal device is invalid or unavailable.
